(19) United States
(12) Patent Application Publication
(10) Pub. No.: US 2026/0178919 A1
(43) Pub. Date: Jun. 25, 2026

(54) DATA-DRIVEN DESIGN EVALUATORS INTEGRATED INTO GENERATIVE ADVERSARIAL NETWORKS

(71) Applicant: Northeastern University, Boston, MA (US)

(72) Inventors: Mohsen Moghaddam, Boston, MA (US); Chenxi Yuan, Springfield, PA (US); Tucker James Marion, Holliston, MA (US); Yi Han, Chelsea, MA (US)

(21) Appl. No.: 19/126,800

(22) PCT Filed: Nov. 3, 2023
(86) PCT No.: PCT/US2023/078635

§ 371 Date: May 2, 2025

Related U.S. Application Data
(60) Provisional application No. 63/422,171, filed on Nov. 3, 2022.

(51) Int. Cl. G06N 3/088; G06N 3/045; G06N 20/00

(52) U.S. Cl. CPC G06N 3/088; G06N 3/045; G06N 20/00

(57) ABSTRACT

Systems and methods are disclosed for integrating a multimodal data-driven design evaluation model into a generative adversarial network. A method for configurating a generative model to generating a sample comprises providing a set of vectors in a latent space to a generator; generating a set of samples, each sample associated with a vector; providing the set of generated samples to an evaluator, and determining a first loss value of a first loss function, the first loss function being based on predicted performance of the set of generated samples; providing the set of generated samples to a discriminator, along with a set of real data samples, and determining therefrom a second loss value of a second loss function, the second loss function being based on performance of the discriminator; determining a composite loss value from the first and second loss values; and training the generator based on the composite loss value.

### RELATED APPLICATION(S)

This application claims the benefit of priority of U.S. Provisional Application No. 63/422,171, filed Nov. 3, 2022, which is hereby incorporated by reference in its entirety.

### GOVERNMENT SUPPORT

This invention was made with government support under Grant Number 2050052 awarded by the National Science Foundation. The government has certain rights in the invention.

### TECHNICAL FIELD

The disclosure is generally directed to generative adversarial networks, and in particular, integration of a multimodal data-driven design evaluation model into a generative adversarial model.

### BACKGROUND OF THE DISCLOSURE

Generative Adversarial Networks (GANs) have shown remarkable success in various generative design tasks, from topology optimization to material design, and shape parametrization. However, most generative design approaches based on GANs lack evaluation mechanisms to ensure the generation of diverse samples. In addition, no GAN-based generative design model incorporates user sentiments in the loss function to generate samples with high desirability from the aggregate perspectives of users.

Embodiments of the present disclosure build and validate a GAN-based generative design model with an offline design evaluation function to generate samples that are not only realistic, but also diverse and desirable. A multimodal Data-driven Design Evaluation (DDE) model is provided to guide the generative process by automatically predicting user sentiments for the generated samples based on large-scale user reviews of previous designs. In exemplary embodiments, DDE is incorporated into the StyleGAN structure, a state-of-the-art GAN model, to enable data-driven generative processes that are innovative and user-centered. The results of experiments conducted on a large dataset of footwear products demonstrate the effectiveness of the proposed DDE-GAN in generating high-quality, diverse, and desirable concepts.

### SUMMARY

According to certain aspects of the present disclosure, devices are disclosed for data-driven design evaluation models.

In one embodiment, a method for configurating a generative model to generating a sample comprises providing a set of vectors in a latent space to a generator; generating a set of samples, each sample associated with a vector; providing the set of generated samples to an evaluator, and determining a first loss value of a first loss function, the first loss function being based on predicted performance of the set of generated samples; providing the set of generated samples to a discriminator, along with a set of real data samples, and determining therefrom a second loss value of a second loss function, the second loss function being based on performance of the discriminator; determining a composite loss value from the first and second loss values; and training the generator based on the composite loss value.

In some embodiments, the evaluator is configured to output predicted performance of each of the set of generated samples with respect to a predetermined set of parameters.

In some embodiments, the evaluator comprises a residual network.

In some embodiments, the second loss function is a Wasserstein Generative Adversarial Network and gradient penalty (WGAN-GP) model.

In some embodiments, the method further comprises training the discriminator based on the second loss value.

In some embodiments, training the generator comprises backpropagation.

In some embodiments, training the discriminator comprises backpropagation.

In some embodiments, the set of vectors comprise random noise samples from a uniform distribution.

In some embodiments, the generated samples comprise an image.

In some embodiments, the evaluator is trained based on a plurality of training images and associated text descriptions.

In some embodiments, the training images comprise one or more image from an internet source.

In some embodiments, the generator and discriminator together form a StyleGAN.

In some embodiments, the set of vectors further comprises a list of features.

In some embodiments, the associated text comprises a user evaluation of a sample design.

In some embodiments, a system comprises a computing node, the computing node comprising a computer readable storage medium having program instructions embodied therewith, the program instructions executable by a processor of the computing node to cause the processor to perform a method comprising any one of the aforementioned methods.

In some embodiments, a computer program product for generating a sample, the computer program product comprising a computer readable storage medium having program instructions embodied therewith, the program instructions executable by a processor to cause the processor to perform a method comprising any one of the aforementioned methods.

### BRIEF DESCRIPTION OF THE DRAWINGS

The accompanying drawings, which are incorporated into and constitute a part of this specification, illustrate various exemplary embodiments and together with the description, explain the principles of the disclosed embodiments.

FIG. 1 is a diagram of the architecture of an exemplary embodiment of the integrated DDE-GAN model.

FIG. 2 illustrates example sneaker images generated using StyleGAN, according to techniques herein.

FIG. 3 is a flow diagram illustrating an exemplary multimodal DDE model, according to techniques herein.

FIG. 4 is a flowchart illustrating an exemplary model for generating samples using an embodiment of the DDE-GAN model, according to techniques herein.

FIG. 5 illustrates example designs generated by an embodiment of the present disclosure, according to techniques herein.

FIG. 6 illustrates example designs generated by an embodiment of the present disclosure, according to techniques herein.

FIG. 7 is a graph illustrating kernel results for embodiments of the present disclosure, according to techniques herein.

FIG. 8 is an exemplary computing node.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

The generation of innovative, diverse, and user-centered design concepts is an essential phase in the early stages of the product development process and is known to have a significant impact on the quality and success of the design. Creating a wide range of solutions that differ significantly from each other can benefit the ideation process of designers and therefore increase the possibility of creating high-quality concepts. Various approaches focus on automatically developing diverse and innovative concepts, reasoning that a large set of concepts promote creativity and logically allows the selection of better ideas from the set. However, it is difficult for designers to manually generate a large set of samples with great diversity and novelty because designers naturally tend to fixate on specific design specifications. Moreover, most existing design problem-solving practices rely heavily on the designers' experiences and preferences. Existing practices also lack advanced computing methods to help navigate larger solution spaces by generating more diverse, unexpected, and viable solutions.

Developing methods to assess and improve creativity has historically been challenging due to its intangible and subjective nature. Engineering design focuses on studying methods and tools to improve the effectiveness and efficiency of creative tasks, such as concept development. Creativity is an essential and central part of the ideation process. In human-led design practices, ideation is often an iterative and exploratory process, where designers share, modify, and use various stimuli to generate new ideas and concepts. Humans approach this process through various cognitive processes, which research has classified into types, and has shown to affect the effectiveness of ideation. Over the past 25 years, research on computers and Artificial Intelligence (AI) has increasingly focused on how these systems can be used to enhance the creative ideation process. With its ability to synthesize data and make predictions at great speed, the potential for AI to be a generator of new and creative design ideas and concepts has garnered substantial attention from both academia and industry.

The methods and frameworks used to apply AI and machine learning in design and engineering are numerous. Deep learning and generative modeling have attracted researchers' attention for their potential impact. Advances in AI research have made remarkable progress in the machine's ability to generate design ideas. AI can be an inspiration tool in the creative process and a generative tool to assist designers in developing design concepts. AI-powered generative design tools can potentially augment designers' ability to create concepts faster and more efficiently due to their increased speed and efficiency. The power of AI lies in the speed with which it can analyze large amounts of data and suggest design adjustments, which the designer can then review and approve adjustments on these data.

An emerging research area on using AI to generate novel and realistic design concepts is the use of Generative Adversarial Networks, or GANs. A typical GAN architecture comprises two neural network architectures: a generator and a discriminator. The generator neural network is trained to generate samples (e.g., images) almost identical to real samples. The discriminator neural network learns to differentiate between them. GANs have made significant progress in synthesizing and generating “realistic” images as their central objective. Several successful GAN architectures have recently been proposed, mainly for synthesizing and generating facial images. Examples include CycleGAN, StyleGAN, PixelRNN, Text2Image, and DiscoGAN. These powerful image synthesis models can generate a large number of high-resolution images that are often difficult to distinguish from authentic images without close inspection. Nevertheless, the question remains on how to leverage these models in early-stage product design to generate realistic but also novel and diverse concepts. Several technical limitations restrict the ability of GANs to generate diverse and novel designs. These include network architectures, training issues, and a lack of reward mechanisms to generate outputs that satisfy metrics other than realism, such as diversity, novelty, or desirability. Taken together, these represent an impediment to design, where novelty and diversity are critical factors in producing beneficial outcomes.

Embodiments of the present disclosure present a data-driven generative design model integrating a Data-driven Design Evaluator (DDE) into GANs. This approach improves performance of GANs though large-scale user feedback on previous designs, thereby providing for diverse and desirable generative design.

Embodiments of the present disclosure incorporate DDE into the StyleGAN structure, a state-of-the-art GAN model, to enable data-driven generative processes that are innovative and user-centered. The results of experiments conducted on a large dataset of footwear products demonstrate the effectiveness of the proposed DDE-GAN in generating high-quality, diverse, and desirable concepts.

State-of-the-art GAN models and architectures such as StyleGAN are not capable of undertaking generative design tasks due to the lack of mechanisms to ensure diversity and desirability. Empirical evaluation of StyleGAN on a large-scale dataset of footwear products reveals that although the model can generate realistic samples, the generated samples are remarkably similar to authentic products in the training dataset. The results may not benefit designers or promote their creativity, as the samples are neither novel nor aligned with user needs.

The described DDE-GAN model of the present disclosure tackles the challenging problem that alternative GAN-based generative design solutions lack efficient mechanisms to guide the generator toward generating samples that are not only realistic but also diverse and desirable (i.e., have high expected sentiment scores, both overall and attribute-level) by devising a novel DDE-GAN model enhanced with DDE as a new loss function for automated design evaluation. The DDE-GAN model can predict user sentiments for each attribute of generated samples and generates design concepts with high quality, desirability, and diversity.

Extensive experiments on a large dataset are described herein. This exemplary dataset was scraped from a major online store for apparel and footwear, to demonstrate the effectiveness of the proposed DDE-GAN model in improving the diversity of generated design samples, as well as their desirability based on predicted user sentiments by comparing it with the StyleGAN model as a baseline. The model is applicable to any other domain, as long as both user data (e.g., reviews, comments) and product data (e.g., images, technical descriptions) are available.

While many generative models are built to create visual designs, creating a design concept with descriptive phrases that can automatically convey a novel design concept remains a challenge. This disclosure describes the use of the pre-trained ResNet network of the DDE model to examine and evaluate the visual samples generated. The DDE model, which excludes inputs from product description, was incorporated into the architecture of the DDE-GAN model. These concepts may be used to construct a multimodal DDE-GAN model that couples images and descriptions for automated generation and evaluation of design concepts.

### GANs for Generative Design: Advantages

Deep generative modeling is one of the most promising areas of modern AI to enhance diversity and performance. One way of design exploration is through generative design, which involves programming that alters design geometry parametrically and evaluates the performance of design output versus configurable constraints. The generative model is an architecture that, given a training dataset, can learn its probability distribution and generate new samples with the same statistics as the training data. Among the generative models, GANs perform well in generating realistic design images. GANs are generative models that involve a minimax game of two players between two models: a discriminative network D and a generative network G. The generator aims to learn a generative density function from the training data to produce realistic samples. In contrast, the discriminator attempts to discern whether an input sample is part of the original training set or a synthetic one generated by the generator in such a way as to distinguish fake samples from real ones. GANs are applicable to various domains such as computer vision, natural language processing, and semantic segmentation. Specifically, GANs have shown significant recent success in the field of computer vision in a variety of tasks such as image generation, image-to-image translation, and image super-resolution.

GANs are applicable to the generation of engineering design, such as the generation of 3D aircraft models in native format for complex simulation, numerous wheel design options optimized for engineering performance, realistic samples from the distribution of paired fashion clothing and the provision of real samples to pair with arbitrary fashion units for style recommendation, and new outfits with precise regions that conform to a description of a language while maintaining the structure of the wearer's body. Where models are built to ensure high quality output, their intrinsic diversity may be limited. The lack of diversity arises because, during the training process, the GAN generator is encouraged to generate samples close to the training data distribution to fool the discriminator in a minimax game. GANs illustrate this proposition, as it prompts the generator G to map an arbitrary noise distribution to realistic samples. On the contrary, the discriminator D tries to distinguish the generated samples from the real ones, resulting in limited diversity and creativity.

Various approaches may be taken to enhance the diversity of GAN-generated image styles. The model can produce diverse outputs by injecting noise vectors, such as the style variation sampled from a normal distribution, into the generator and sampling different style codes. Modes may be introduced as an additional input to transform conditional input into the target distribution. The predetermined label is fed to the generator, which helps the model produce deterministic outputs that can map different visual domains and styles, which has been shown to successfully generate diverse outputs from a given source domain image.

It has also been observed that the generators are most likely to generate samples from certain major modes/styles in the data but ignore the other modes, for example, the modes that take a small count of distributions. This problem is known as the “mode collapse” and is a primary factor in the lack of diversity in GAN-generated samples. To address this problem, a regularization term may be used to maximize the distance between the generated outputs and the generated samples with latent codes injected. A diversity augmented conditional GAN (DivAugGAN) further prevents mode collapse and improves the diversity of generated images by using three randomly sampled latent codes and two relative offsets. The model exerts a constraint on the generator to ensure that the changing scale of the generated samples is consistent with the various vectors injected into the latent space. Introducing a regularizer to GAN can address the model collapse problem and thus improve the diversity and quality of generated samples. If GANs are pushed too far from the data distribution for design generation, the quality and realism of the generated samples will be negatively affected. Modifications to the GAN objective have been proposed to allow it to generate creative art by maximizing the deviation from established styles while minimizing the deviation from the art distribution. Improving diversity may cause GANs to deviate slightly from the original distribution. With this motivation, embodiments of the present disclosure include a new GAN architecture that can guarantee high quality and also improve the diversity and desirability of the generated samples.

### Traditional Generative Design Methods Versus GANs

Various generative design methods may be employed to assist designers in the creative ideation process. Generative design is a design exploration method that can enable simultaneous exploration, validation, and comparison of thousands of design alternatives to support designers and/or automate parts of the design process. There are five commonly used generative design methods, including cellular automata, L-systems, shape grammars, genetic algorithms, and swarm intelligence. Cellular automata are characterized by the simplicity of its mechanisms and the potential complexity of its outcomes. Cellular automata can modify design specifications according to predefined rules and produce unexpected design concepts. L-systems produce samples by providing a programmable rewriting paradigm that are particularly sensitive to changes in expression, making the final rendering particularly challenging to predict. Shape grammars are geometry-based generative systems that describe how complex shapes are built from simple entities, and how a complex shape can be decomposed into simpler sub-shapes. Unlike conventional generative design methods that only require initial communication from designers, shape grammars involve designers more in making decisions throughout the generative process stage. Genetic algorithms, the most widely used method in generative design exploration, are applied as a generative and search procedure to look for optimized design solutions and have the ability to modify the sequence of the rules of design generation process to assist the designer in generating specific parts of a solution. Swarm intelligence is inspired by natural phenomena, in which flying or swimming animals move together in packs and allows the system to interact locally with autonomous computational agents to achieve heterogeneous phenomena in generative processes. Despite these generative design methods' significant progress and success, several critical knowledge gaps remain. Most importantly, product forms in these quantitative design methods are typically expressed with a mathematical representation such as vectors, trees, graphs, and grammars, therefore, limiting the trade-off between flexibility and realism.

Deep generative models may be employed to enable more effective and diverse concept generation as an alternative solution for generative design. Specifically, GANs are useful in a variety of generative design tasks, such as topology optimization, material design, and shape parametrization. To better understand how GANs work for generative design purposes, a brief comparison between GANs and the five conventional generative design methods is conducted as follows.

### GANs and Cellular Automata

In conventional cellular automata, generative rules are predefined, usually following basic transformations. GANs are composed of many convolutional layers, and cellular automata can be represented using a convolutional neural network with a network-in-network architecture. Therefore, a sufficiently complex neural network architecture, such as GAN, can be used to approximate each rule that fully comprises the cellular automata function. Moreover, the states of neurons in a neural network are continuous, whereas cells in cellular automata have discrete states. In addition, neural networks are primarily concerned with the output and not with the states of individual neurons, whereas the output of cellular automata is a collection of its states.

### GANs and L-Systems

An L-system is a programmable rewriting paradigm for producing samples. It is challenging to predict the final rendering from the expression of the L-system alone since it is particularly sensitive to changes in expression. The deterministic L-system does not solve the lack of variability for more realistic outputs. GANs automatically discover and learn production rules by reading a large dataset. Beyond deterministic restrictions, GANs investigate alternative rules and relationships between characteristics. Because of the powerful processing power of GANs, they are smart enough to comprehensively learn the distribution of the training samples and reconstruct them. Consequently, GANs can guarantee the quality and realism of the results generated, unlike L-systems.

### GANs and Shape Grammars

Shape grammars allow for the addition and subtraction of shapes that are eventually perceived as shape modifications. If the shape on the left side of a rule matches a shape on a drawing, then the rule can be applied, and the matching shape changes to match the right side of the rule. The generator and discriminator of a GAN model are similar to the left- and right-hand sides of a shape grammar, respectively. The generator sample (equivalent to the left side of a shape grammar) is validated as real by the discriminator (equivalent to the right side of a shape grammar). The generating rule (latent representation learned by GAN) can then be reinforced in the next iteration of the training process, similar to shape grammars.

### GANs and Genetic Algorithms

Genetic algorithms are evolutionary algorithms widely used to explore and optimize a generative design. The adversarial training procedure of a GAN can be regarded as an evolutionary process. That is, a discriminator acts as the environment (i.e., provides adaptive loss functions), and a population of generators evolves in response to the feedback from that environment. Genetic algorithms use a form of sampling to measure the relationship between a change in a parameter and a change in the fitness (loss). In contrast, neural networks give a means to directly calculate that relationship without sampling. Therefore, the speedup experienced when training a neural network is the result of not needing to gather as many samples as the number of parameters to tune.

### GANs and Swarm Intelligence

Swarm intelligence involves a collective study of how individuals act in their surrounding environment and interact with each other. It has shown benefits in simplicity, ease of implementation, lack of need for gradient information, and low parameter requirements. Of the five methods, swarm intelligence most closely resembles GANs. Although GANs are highly dependent on various parameters and the backpropagation process to alter each layer to affect the loss function, mode collapse is a frequent issue. To prevent mode collapse, swarm intelligence can be employed to improve the generator's performance in GAN and minimize iterations differently from conventional methods.

Existing work on GANs lacks sufficient evaluation mechanisms for desirability and diversity that would make GANs suitable for generative conceptual design. The ability of a model to generate concepts with iterative updating from evaluation and feedback has the potential to lead to more creative and valuable design outcomes. The rationale is that the generative process must continually evaluate the generated samples concerning not only realism but also desirability and diversity; otherwise, the number of generated samples with lower desirability or diversity will continue to grow without improvement, making it impossible for designers to consider them meaningfully and accordingly. Alternative models may include GAN-based generative models built with such evaluation processes; however, such approaches are exclusively based on physics-based virtual simulation environments that do not necessarily reflect user feedback.

To address various shortcomings of alternative approaches, a user-guided evaluation DDE-GAN model is provided herein to enhance a generated design's quality, diversity, and desirability by incorporating synthetic user feedback from an evaluation process for its generated intermediate samples.

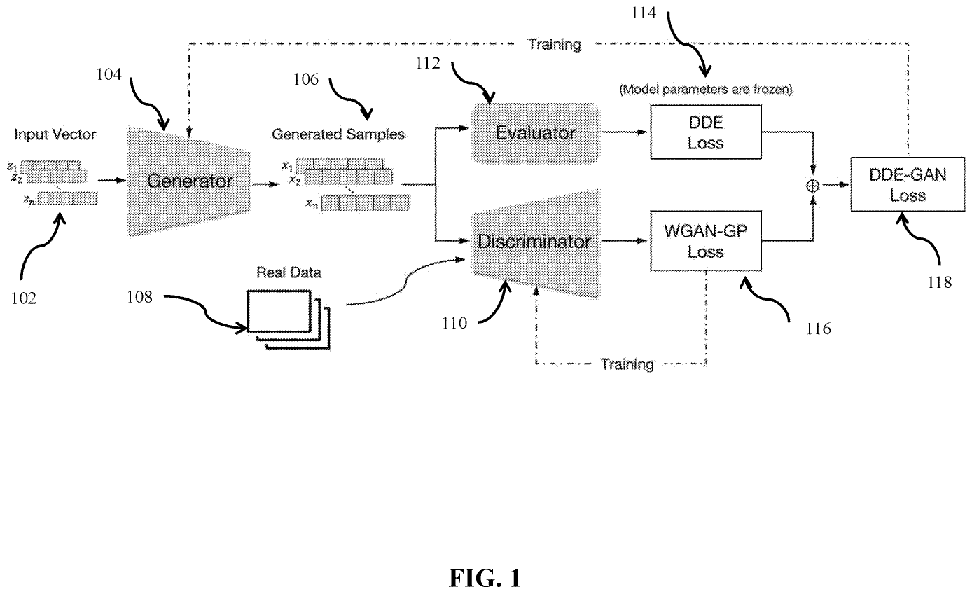

FIG. 1 is a diagram of the architecture 100 of an embodiment of an integrated DDE-GAN model according to the present disclosure. In architecture 100, an input vector 102 of size n is provided to a generator 104. The generator 104 outputs a series of n generated samples 106.

The generated samples 106 are then provided to an evaluator 112 and a discriminator 110. Real data 108 is provided to the discriminator 110 along with the generated samples 106. An output is sent from the discriminator 110 to a Wasserstein GAN and gradient penalty (WGAN-GP) loss model 116. The output of the WGAN-GP loss model 116 may be used to iteratively train the discriminator 110.

The evaluator 112 provides an output that is in turn provided to a data-driven design evaluation (DDE) loss model 114. At the DDE loss model 114, model parameters are frozen. The output from the DDE loss model 114 is combined with the output from the WGAN-GP loss model, and both are input to the DDE-GAN loss model 118. The DDE-GAN loss model 118 is used to iteratively train the generator 104, as needed.

### Methodology

StyleGAN is applied as a baseline comparison to embodiments of the present disclosure, and the novel loss function of the DDE-GAN model shows improvement over the loss function of StyleGAN. The DDE-GAN is described below, followed by details of the DDE model. The DDE model accurately predicts the overall and attribute-level desirability of a new concept based on large-scale user sentiments and feedback on past designs. Some embodiments of the present disclosure apply a well-trained DDE model as an augmented discriminator to promote user-centered image generation using the StyleGAN model, to generate realistic, diverse, and desirable samples.

### GAN Formulation

GANs can generate images from random noise and do not require detailed information or labels from existing samples to begin the generative process. The standard GAN structure consists of two neural networks: a generator G and a discriminator D, as shown in FIG. 1. The generator G takes random noise z˜P(z) sampled from a uniform or normal distribution as input and maps the noise variable z˜P(z) to the data space x=G(z). The discriminator D distinguishes whether an image is real or fake (i.e., made by the generator). The output D(x) is the probability that the input x is real. If the input is a fake image, D(x) would be zero. Through this process, the discriminator D is trained to maximize the probability of assigning the correct label to both real samples and fake samples. Generator G is encouraged simultaneously to fit the true data distribution. The adversarial training processes that update the parameters of both networks through backpropagation are formulated as the following learning objective:

$${min}_{G} {max}_{D} {𝔼}_{x ∼ {ℙ}_{r}} [ log ( D ( x ) ) ] + {𝔼}_{\tilde{x} ∼ {ℙ}_{g}} [ log ( 1 - D ( \tilde{x} ) ) ] \qquad ( 1 )$$

where [symbol] is the distribution of the real image x and [symbol] _{g} is the prior distribution defined by G(z), z˜p(z). [symbol] _{z} is a random or encoded vector sampled from a noise distribution (e.g., normal distribution).

GAN models come in various forms, StyleGAN being one example. The StyleGAN extension to the GAN architecture proposes a major modification to the generator model, which uses (1) a mapping network to transfer latent space points to an intermediate latent space, (2) an intermediate latent space to regulate style at each point in the generator model, and (3) an addition of noise as a source of variation at each point in the generator model. StyleGAN features a style-based generator architecture that creates high-resolution images with high visual quality. the model also provides control over the style of the generated image at various degrees of detail by adjusting the style vectors and noise. Moreover, most GAN-variants are generally sensitive to the problem domain. They perform exceptionally well in processing generative tasks using large popular datasets such as human faces and animals, where the novelty, diversity, or desirability of the generated samples are not important.

However, their limitation becomes evident in generative design tasks where the quality, diversity, and desirability of samples must be optimized simultaneously. The loss function utilized in StyleGAN is WGAN-GP, which is the most widely used loss function. WGAN-GP is constructed with the Wasserstein GAN formulation along with a gradient norm penalty to achieve Lipschitz continuity. The Wasserstein loss formulation applies the Wasserstein-1 distance using a value function based on Kantorovich-Rubinstein duality. The loss function (1) is then modified as follows:

$${min}_{G} {max}_{D} {𝔼}_{x ∼ {ℙ}_{r}} [ ( D ( x ) ) ] + {𝔼}_{\tilde{x} ∼ {ℙ}_{g}} D ( \tilde{x} ) \qquad ( 2 )$$

where D is the set of 1-Lipschitz functions and P_{g} is the distribution of the model implicitly defined by \tilde{x}==G(z),z˜P(z). The Wasserstein loss is approximated given a set of k-Lipschitz, and the weights of the discriminator are clipped to some range. By adding the Wasserstein loss with gradient penalty, WGAN-GP enforces a soft restriction on the gradient norm of the discriminator's output with respect to its input rather than clipping network weights, to guarantee the Lipschitz requirement. The objective function of StyleGAN is then formulated as follows:

$$L = {𝔼}_{\tilde{x} ∼ {ℙ}_{g}} [ D ( \tilde{x} ) ] - {𝔼}_{x ∼ {ℙ}_{r}} [ D ( x ) ] + {λ}_{GP} {𝔼}_{\hat{x} ∼ {ℙ}_{\hat{x}}} [ ( ‖ {∇}_{\hat{x}} D ( \hat{x} ) {‖}_{2} - {1}^{2} ] \qquad ( 3 )$$

where \tilde{x} is a random sample, [symbol] _{\hat{x}} is defined as samples along straight lines between pairs of points that come from the true data distribution and the generator distribution, and [symbol] _{GP} is a weighing factor.

### Data-Driven Design Evaluator Loss

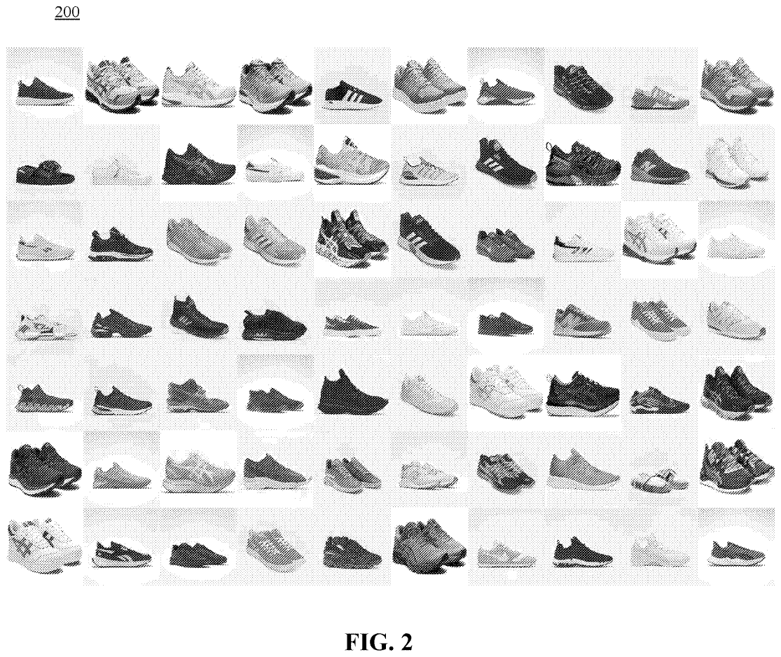

Experiments conducted to generate images of footwear products using StyleGAN revealed that although the model is capable of generating realistic samples, the generated samples are remarkably similar to the real products in the training dataset. These similarities can even be detected by simple visual inspections (see FIG. 2). FIG. 2 illustrates examples of sneaker images generated with StyleGAN. With a sufficiently trained generator, even the discriminator would be unable to distinguish between the generated samples and the real ones. Although the generated images are realistic, they may not benefit designers or promote their creativity as the samples are not necessarily novel or aligned with user needs. While the model training procedure considers algorithmic quality, it does not consider how users will receive and react to these computer-generated designs. This problem comes from the sole objective of existing generator-discriminator architectures to maximize “realism.” There is an absence of a loss function that can incorporate other critical metrics in addition to realism, such as the alignment of the generated samples with the perspectives and needs of users, which could cause the discriminator to fail when updating the generator in terms of learning and producing features that maximize the usefulness of a design. To convey the measurement of the design performance score back to the generator for subsequent iteration improvements, new loss functions are needed to force the discriminator to identify and locate other metrics, such as novelty or desirability. This observation led to the investigation of when to incorporate the user-guided assessment mechanism into the discriminator, as described below, if the similarity between the produced and real images is effectively reduced.

Embodiments of the present disclosure apply DDE as a user-centered design evaluation model to evaluate the generated samples with respect to the expected quality and performance of the generated designs. DDE is a multimodal deep regression model that uses an attribute-level sentiment analyzer to predict user-generated product ratings based on online reviews. DDE was created to automate design evaluation and improve decision-making by domain experts. Based on extensive user evaluations of existing designs, the DDE model offers designers a precise and scalable means to forecast new concepts' overall and attribute-level desirability. DDE is an end-to-end design assessment system that can interpret visuals, plain language, and structured data.

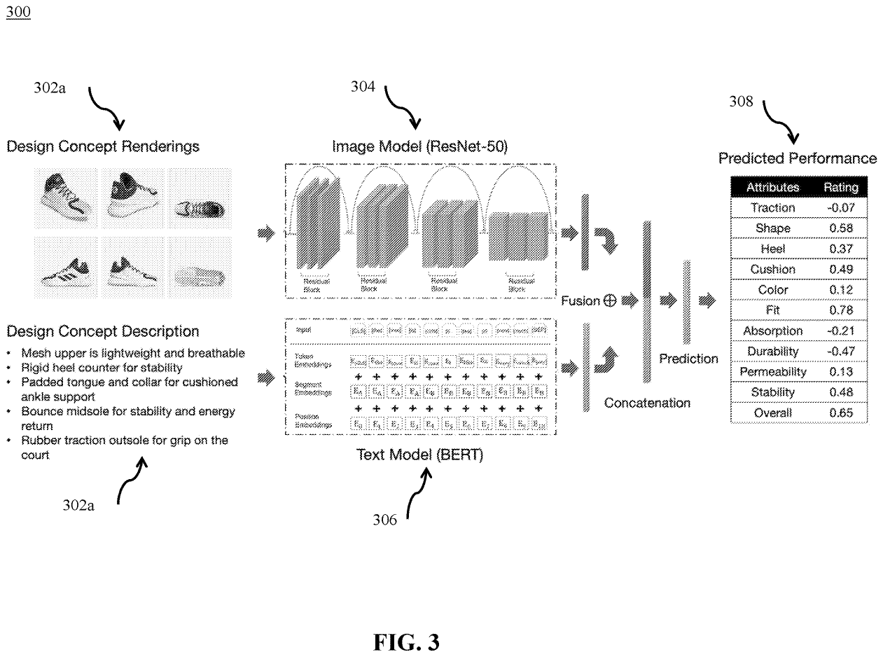

FIG. 3 illustrates an exemplary multimodal DDE system 300. The DDE system 300 beings with a series of design concept renderings 302a. The design concept renderings 302a may comprise a series of views of the concept, and are accompanied by a design concept description 302b of the design, with key features and details described in text. For example, the design concept description 302b can include statements such as “mesh upper is lightweight and breathable,” “rigid heel counter for stability,” or “padded tongue and collar for cushioned ankle support.” The design concept renderings 302a are input to an image model 304 and the design concept description 302b are input to a text model 306.

As shown in FIG. 3, the DDE system 300 uses a ResNet-50 image model 304 to evaluate and interpret images of a product. The ResNet-50 image model 304 comprises a series of residual blocks which analyze input images. Image model 304 can represent complex functionality and learn features at many different levels of abstraction to understand the connections between orthographic representations of design concepts (inputs, such as design concept renderings 302) and user sentiment intensity values (outputs). The Bidirectional Encoder Representation from Transformers (BERT) text model 306, a different model in the DDE system, extracts and analyzes product descriptions written in natural language, with inputs broken down by word and analyzed though a series of token, segment, and position embedding steps. The BERT text model 306 can determine the connection between a product's technical description and the user's emotional sentiment level. The outputs from the image model 304 and the text model 306 undergo a fusion step as well as concatenation before the prediction occurs.

The DDE system 300 then integrates the various meaningful data collected from the Internet platform, as described below, and models the relationships between images, text, and statistics. The DDE system 300 synthesizes different modes of data using a novel fusion mechanism to develop a more accurate context for the product and the associated user feedback. For the illustrated embodiment, the DDE system 300 was trained on a large-scale dataset that was scraped from a major online footwear store. In the dataset, each product has four types of information: six orthographic images, one numerical rating score, a list of textual product descriptions, and real textual customer reviews from an e-commerce platform, where images and feature descriptions are the inputs to the DDE system 300 and the numerical rating score and sentiment intensity values from customer reviews are the outputs. The dataset is constituted of a total number of 8,706 images and 113,391 reviews for 1,452 identified shoes. From this input data, the DDE system 300 outputs a predicted performance 308 with rating of each identified attribute. Numerical experiments on this large dataset indicated promising performance by the DDE system 300 with 0.001 MSE loss and over 99.1% accuracy.

The DDE model can accurately predict user sentiments for a new design concept based only on its orthographic images and descriptions and provide numerical design performance values associated with each attribute of the generated concept. Embodiments of the present disclosure build a novel loss function based on the DDE model, called the DDE loss, into the GAN's discriminator to enable an accurate and scalable prediction of the new concepts' overall desirability. By integrating the DDE loss into the StyleGAN's discriminator, the DDE-GAN model is created (FIG. 1). The DDE loss integrated into the discriminator can measure the intermediate samples generated by the generator in each iteration and convey the loss back to the generator for a new set of parameters. The DDE loss evaluates the results of each round in the iterative training process, which is then used to backpropagate and optimize the generator and the discriminator. The DDE-GAN architecture results in better designs from the user's point of view and simultaneously maintains excellent image quality.

The objective function of the DDE-GAN model is therefore formulated as follows:

$$L = {𝔼}_{\tilde{x} ∼ {ℙ}_{g}} [ D ( \tilde{x} ) ] - {𝔼}_{x ∼ {ℙ}_{r}} [ D ( x ) ] + {λ}_{GP} {𝔼}_{\hat{x} ∼ {ℙ}_{\hat{x}}} [ {( ‖ {∇}_{\hat{x}} D ( \hat{x} ) {‖}_{2} - 1 )}^{2} ] + {λ}_{DE} {𝔼}_{\hat{x} ∼ {ℙ}_{g}} [ {ℒ}_{DE} ( \tilde{x} ) ] \qquad ( 4 )$$

$${ℒ}_{DE} ( x ) = \frac{1}{N} {\sum }_{i = 1}^{N} {( {f}_{i} ( x ) - {\hat{y}}_{i} )}^{2} \qquad ( 5 )$$

where [symbol] _{DE} is a constant that defines the loss weight, [symbol] _{DE} is the DDE loss function to evaluate the feature of the generated samples in the characteristic of performance, fᵢ(x) is the prediction for all design x generated by the DDE model, and ŷᵢ is the desired design evaluation score and is set as 1 for each attribute, indicating that the models are trained to generate samples with the highest possible expectation. The StyleGAN loss terms regulate the high quality of the produced pictures and the DDE loss guarantees that the produced samples have high user sentiment scores. Combining the two elements allows the proposed DDE-GAN model to simultaneously create high-quality images and high user sentiment ratings. This new set of loss functions provides a more accurate and evaluation-guided generator and discriminator in DDE-GAN compared to previous models and can be easily tuned.

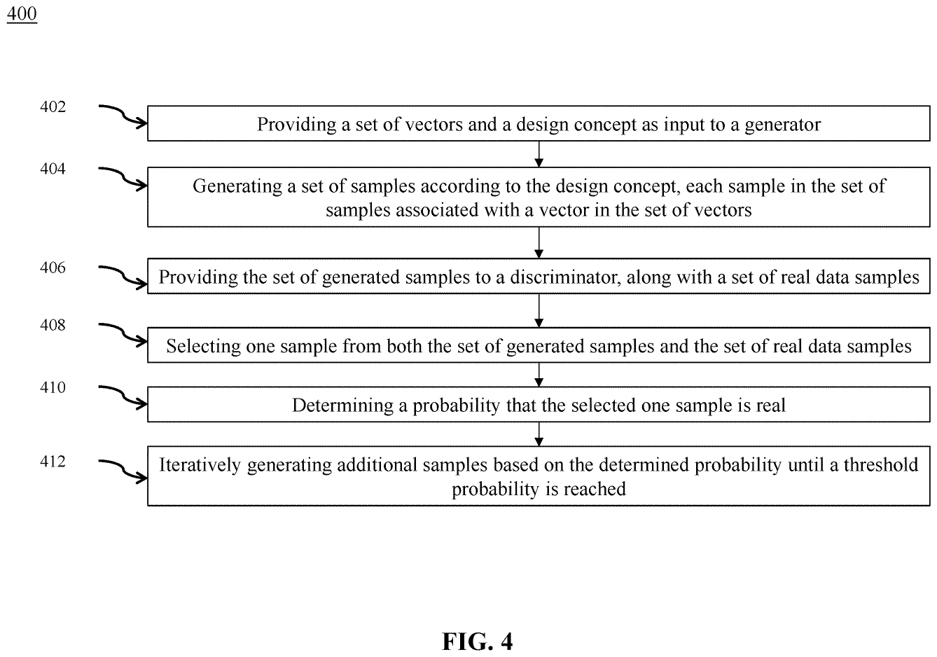

FIG. 4 is a flowchart illustrating an exemplary process 400 for generating samples using an embodiment of the DDE-GAN model, according to techniques herein. Exemplary method 400 (i.e., steps 402-412) can be automatic or started by a user request. In step 402, the method may include providing a set of vectors in a latent space of a generative model and a design concept as input to a generator. The set of vectors may be random noise, as the generator does not require detailed information or labels from existing samples to start the generative process. In some embodiments, the input vectors may represent preexisting images. The design concept may be a textual input describing key features of the ending product output of the exemplary process 400.

In step 404, the process may include generating a set of samples according to the design concept, each sample in the set of samples associated with a vector in the set of vectors. In some embodiments, the generated samples may be images generated with consideration of the input design concepts. For example, if the input design concept is “shoe with gripping surface on the sole of the shoe,” the output image may be a shoe with a sole designed to increase traction between the shoe and ground. This generation step may be implemented by inputting existing images corresponding to the design concepts into the generator to be used as reference.

In step 406, the process may include providing the set of generated samples to a discriminator, along with a set of real data samples. The real data samples may be integrated with the set of generated samples, to form a nondiscriminatory set of samples for the discriminator to analyze.

In step 408, the process may include selecting one sample from both the set of generated samples and the set of real data samples. The sample may be randomly selected.

In step 410, the process may include determining a probability that the selected one sample is real. For example, if the selected sample is easily determined to be “fake” (i.e., generated), the probability is zero. The discriminator is trained to maximize the probability of assigning the correct label to both real samples and fake samples. The generator is simultaneously encouraged to fit the true data distribution with the generated samples. Adversarial training processes update the parameters of both networks through backpropagation.

In step 412, the process may include iteratively generating additional samples based on the determined probability until a threshold probability is met.

### Experiments

Below, the dataset and implementation details of embodiments of the DDE-GAN model are described, followed by the introduction of metrics established to investigate the effectiveness of the developed DDE-GAN model in generating realistic samples with high desirability and diversity. The results of the experimental analyses are presented next, comparing the outcomes generated by the developed DDE-GAN model and the StyleGAN model as a baseline.

### Dataset and Implementation Details

To test and validate the performance of StyleGAN in generating realistic and diverse images, a large-scale dataset was scraped from a major online footwear store to perform numerical experiments. The collected largescale dataset contains a total of 7,642 images with a size of 256×256×3. Several brands of footwear are included in the dataset to avoid mode collapse and increase the diversity of the dataset, including Adidas, ASICS, Converse, Crocs, Champion, FILA, PUMA, Lacoste, New Balance, Nike, and Reebok.

The DDE model is pre-trained and serves as an offline network added to the new StyleGAN loss. The implementation of the pre-trained DDE model is discussed herein. The experiments were carried out with k fold, with k=10, to randomly split the dataset into train, validate, and test sets with a 7:1 2 ratio. All experimental results were conducted five times and reported as mean±std to alleviate the randomness effect. All neural networks were trained on PyTorch. An optimizer with β=(0.9,0.999) and the learning rate of =0.01 were used to train the model parameters for 50 epochs and save the model with the best loss in the validation dataset. To avoid overfitting, a dropout layer was added to the self-attention fusion model with a dropout rate of P_{drop}=0.1. The DDE model was trained over 40 epochs. The training time cost per epoch was 5-7 minutes, which added up to 3-4 hours. All training and testing experiments were conducted on a single NVIDIA RTX 3090 GPU (24 GB GRAM), an AMD Ryzen 9 5950X CPU, and 64 GB memory.

The weight of StyleGAN, XGP, was precisely calibrated with the best performance achieved. The example embodiment uses the same value of 0.8192 as suggested by StyleGAN references. The weight of DDE loss, XDE, is defined by binary search from 0.1 to 2 in general, and finally is set as 0.5 to meet the trade-off between high image quality (FID) and predicted sentiment scores. The optimizer has a learning rate of 0.0025 to optimize the model and sets R as (0.9,0.999), representing the coefficients used for computing running averages of gradient and its square. Beyond that, data augmentation methods such as random flip, rotation, scale, brightness, and contrast were applied to improve data diversity. The model was trained 20,000 times for each experimental setting, and the average performance statistics were reported.

### Evaluation Metrics

Frechet Inception Distance (FID) is used to assess the quality of the images created by a generative model. FID evaluates the statistics for both the target and output images simultaneously, comparing the distribution of the generated images with the distribution of real photos used to train the generator. FID can also identify intraclass mode dropping and quantify the variety and quality of produced samples, making it a valuable tool for assessing the quality and diversity of synthetic images. A lower FID score intuitively indicates a closer distribution between the objectives and the results, which corresponds to a better performance of the generative model. Embodiments of the DDE-GAN model is compared with the GAN architecture, StyleGAN, in terms of FID, using the following equation:

$$FID = {‖ {μ}_{r} - {μ}_{ℊ} ‖}^{2} + Tr ( {Σ}_{r} + {Σ}_{ℊ} - 2 {( {Σ}_{r} {Σ}_{ℊ} )}^{\frac{1}{2}} ) \qquad ( 6 )$$

where Tr refers to the trace linear algebra operation, (μᵣ, Σᵣ) and (x_{g}, Σ_{g}) refer to the mean and covariance matrices in the feature order of the embeddings obtained in real and generated images, respectively.

### Diversity Assessment

To quantitatively measure whether the DDE-GAN model has guided the generator to synthesize new designs with greater variety, a kernel-based statistical test method called Maximum Mean Discrepancy (MMD) is used to determine the similarity between two distributions. MMD is defined by the idea of representing the distances between the distributions as the distances between the mean embeddings of the features. Given two sets of data X and Y, the MMD is calculated as the distance between the feature means of X and Y. The expression is formulated as follows:

$${MMD}^{2} ( P , Q ) = {E}_{P} [ k ( X , X ) ] - 2 {E}_{P , Q} [ k ( X , Y ) ] + {E}_{Q} [ k ( Y , Y ) ] \qquad ( 7 )$$

where k is the kernel function, P is the distribution over a set of input data X, and Q is the distribution over a set of generated data Y. Embodiments of the present disclosure use two different kernel functions: a linear kernel and a polynomial kernel. The linear kernel is defined as:

$$k ( x , y ) = {x}^{T} y \qquad ( 8 )$$

and the polynomial kernel is defined as:

$$k ( x , y ) = {( {γx}^{T} y + {c}_{0} )}^{d} \qquad ( 9 )$$

where x and y are the input vectors, d is the degree of the kernel, γ is the weight, and c₀ is a constant. In the experiments, the polynomial kernel γ is set to 1, the kernel degree d is set to 0.5 and the coefficient c₀ is set to 0.

### Results and Analyses

To test and validate the performance of the proposed DDE-GAN model for design generation with improved desirability and diversity, a set of experiments was performed on a real dataset of footwear products with StyleGAN as the baseline model. The performance of the proposed model is then compared with the baseline using the FID score, followed by an MMD analysis to examine the similarity between the generated images and the real images. Lastly, DDE is applied to test the images generated by the DDE-GAN and StyleGAN models to evaluate their desirability prediction scores.

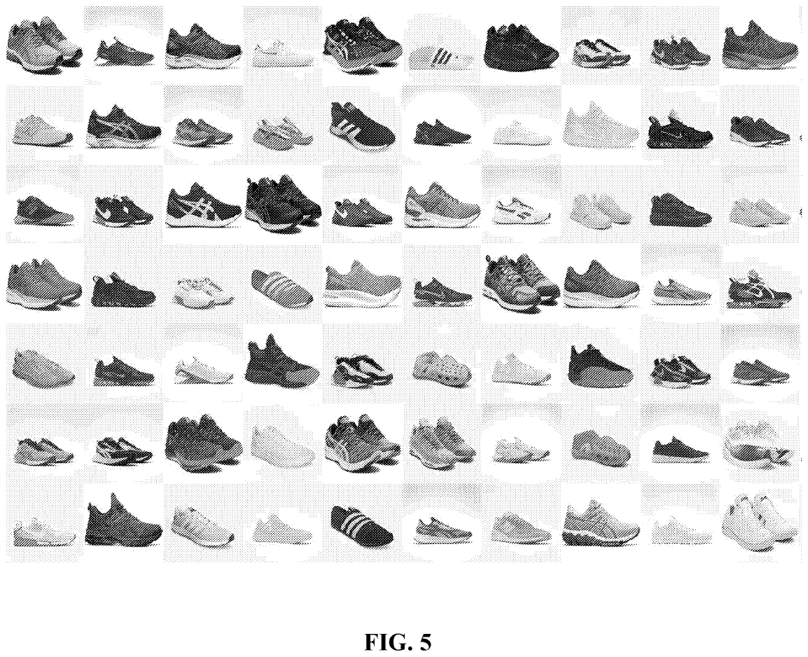

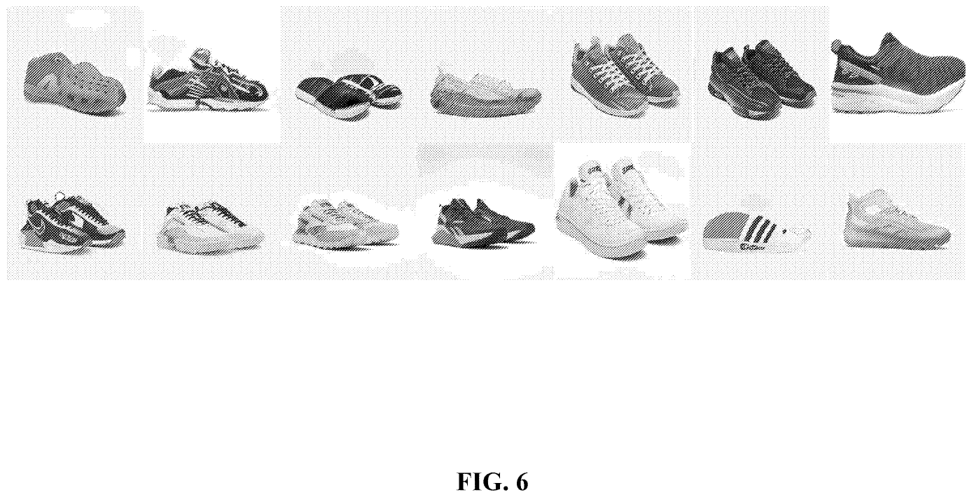

As shown in FIG. 5, the DDE-GAN generated samples deliver the expected high quality and realism, which are also observed in the StyleGAN generated samples (FIG. 2). The overall images are realistic, vibrant, clear, and have an aesthetic understandable to the human mind. Although FIG. 5 reveals some differences, the uniqueness and diversity of the images are discovered in some samples. Some images contain features that might sound novel or even strange. However, these characteristics are viewed as new and diverse. It is noticed that most of the generative model samples generated in the current GAN-based design literature emphasize quality, while the images are somehow similar to existing products. Yet, that may hinder innovation in the generative process, because a conventional GAN discriminator may easily label a “novel” sample that could potentially be an interesting sample from the design perspective as “fake”, simply because it does not look like any real item within that category and contains unknown features. This, in turn, would discourage the conventional GAN generator from generating more of these potentially novel samples. The DDE-GAN model introduces an additional loss to encourage the generator to produce more novel and distinctive images. Therefore, attributes such as “strange” or “never seen before” are defined as one of the diversity criteria. Among the large size of the generated samples, 16 distinct images are manually selected and presented in FIG. 6, as they are identified as designs with novelty and diversity. It is clearly seen that these sneakers are far from “similar” to existing sneakers, compared to the other samples shown in FIG. 5. They look distinguishable with more novelty and diversity. To further validate the effects of the DDE-GAN model on novelty and diversity, a quantitative analysis of FID and MMD was conducted.

TABLE 1
Comparison of the average FID score of the
best generators in StyleGAN and DDE-GAN.

| Algorithm | FID Score |
|---|---|
| StyleGAN | 6.22 ± 0.17 |
| DDE-GAN | 6.45 ± 0.21 |

Table 1 shows the FID scores of the best samples for each generation when training models with the collected dataset. The FID scores are the mean values for ten different training results. As shown in Table 1, the StyleGAN model produces a lower FID score than the DDE-GAN model. A lower FID score means that the model is more stable and correlates better with higher-quality images. However, the FID score of the DDE-GAN model and its standard deviation are close to StyleGAN with only a small change (0.23 decrease), and it is empirically concluded that an FID score below 10 is sufficient to demonstrate the effectiveness of a generative model. In addition, the difference between DDE-GAN (mean=6.45) and StyleGAN (mean=6.22) is verified with t-test, P=0.0026. Therefore, the DDE-GAN model performs well in achieving high-quality results. FID can also be explained as a similarity metric because it calculates the distance between the feature vectors calculated for the real and generated images. Lower scores indicate the two groups of images are more similar, or have more similar statistics, with a perfect score being 0.0 indicating that the two groups of images are identical. Therefore, from the perspective of similarity, Style-GAN with lower FID represents that the generated samples are more similar to real images compared with the DDE-GAN with a higher FID score. DDE-GAN with higher FID reveals that the generated samples are distinct from existing images.

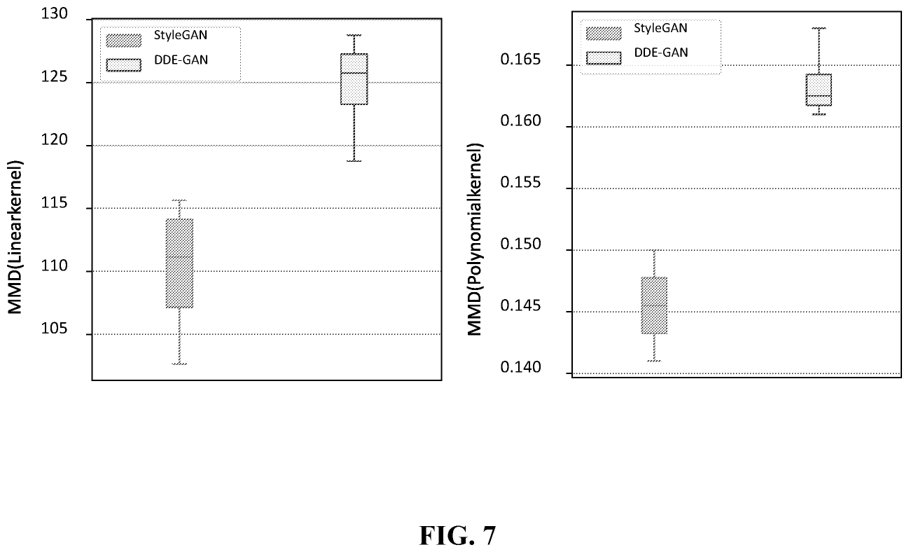

The primary rationale behind the proposed DDE-GAN model is to promote the diversity of images generated by GAN. The similarity between the produced samples and the original input is calculated using the MMD metric to estimate the diversity of novel samples. A higher similarity value indicates that the generated samples contain less diversity, and vice versa. The MMD (Maximum Mean Discrepancy) values are calculated based on the results of the proposed model and the baseline model, using linear and polynomial kernels, as shown in FIG. 7. The proposed DDE-GAN model is observed to produce higher MMD scores than the baseline StyleGAN model, indicating a significantly lower similarity between the real training dataset and the samples generated by the DDE-GAN model. For the linear kernel, StyleGAN receives a mean of 124.77 and a standard deviation of 3.74, and DDE-GAN obtains a lower mean of 110.15 with a lower standard deviation of 5.02. The mean and variance of the polynomial kernel are (0.145, 0.003) and (0.164, 0.002) for DDE-GAN and StyleGAN, respectively. A statistical test examines the difference between the performances of the two models. Results of assessments using linear kernel MMD show that the DDE-GAN model (mean=110.15; t test p=3ₑ⁻⁰⁸) significantly outperforms StyleGAN (mean=124.77) in generating samples with high diversity. Likewise, StyleGAN, assessed using polynomial kernel MMD, is shown to perform worse in generating diverse samples (mean=0.144) compared to DDE-GAN (mean=0.163; t test P=4e-14). Overall, DDE-GAN performs well in generating images with less similarity to the original dataset and more diversity.

In addition to enhancing the diversity and novelty of the generated images, another objective regarding embodiments of the present disclosure is to build a user-guided automated generative design model that can produce designs that meet the desirability requirements. The DDE model was trained on a large dataset of 1,452 design images labeled with user sentiments to learn and capture the relationship between images and attribute performance. The DDE model creates a collection of rating scores representing the performance of relative attributes when images of testing products are imported into the model. The number of products with an absolute value of the desired values and the predicted values below a threshold was counted using the Prediction Accuracy Rate (PAR) metric. The percentage of the counted number to the overall testing number serves as the accuracy metric. The well-trained DDE model was verified to predict user sentiments for a new design concept based only on its orthographic images and provides the numerical values of the design performance associated with each product attribute with a prediction accuracy of 76.54%. To test whether the new designs produced by DDE-GAN perform better than the designs created by StyleGAN, all 480 images were selected from the output of two models and tested using a well-trained DDE model to predict their overall and attribute-level desirability based on large-scale user reviews on existing products. The average numerical values of user sentiments in 10 attributes and the overall performance of the designs are shown in Table 2 in which the sentiment intensity of users ranges from [−1,1], with −1 and 1 representing extremely negative and extremely positive sentiment, respectively. DDE-GAN is observed to generate designs with higher expected user sentiment values for most individual attributes and overall performance. In general, the predicted sentiment values of individual attributes of the samples created by DDE-GAN obtained increases of 9%-56% compared to StyleGAN, except for the attribute “Fit.” To further explore the differences between the two models, the predicted sentiment values of the two models are analyzed by two-tailed independent samples t-tests, tested for significance at p<0.05. As shown in Table 2, there is a significant improvement associated with the attributes “Traction”, “Shape”, “Heel”, “Cushion”, “Color”, “Impact absorption”, “Permeability”, “Stability” and the “Overall” rating of whichp-values are much less than 0.05. However, the prediction performance of the two models was not significantly different for the attributes “Fit” and “Durability” (p-value 0.0803 and 0.0334, respectively). The statistical test strongly verifies that the additional loss function in conjunction with the discriminator successfully improves the generator to learn features corresponding to user sentiments and design desirability. The evaluation results indicate that DDE-GAN-generated design samples will lead to greater user satisfaction compared to StyleGAN generated samples that focus only on the “realism” of the generated samples. The proposed DDE-GAN model is optimized to serve effectively as a user-centered generative design framework.

TABLE 2
Results of the DDE test regarding “predicted
sentiment values” on 480 randomly selected
samples generated by StyleGAN and DDE-GAN.
Predicted Sentiment Value

| | Model | | | |
|---|---|---|---|---|
| Attributes | StyleGAN | DDE-GAN | Change(%) | P-value |
| Traction | 0.1652 ± | 0.2064 ± | 25% | 0.0035 |
| | 0.018 | 0.018 | | |
| Shape | 0.2831 ± | 0.3097 ± | 9% | 0.0074 |
| | 0.016 | 0.024 | | |
| Heel | 0.3736 ± | 0.5142 ± | 38% | <0.0001 |
| | 0.020 | 0.015 | | |
| Cushion | 0.1924 ± | 0.3005 ± | 56% | <0.0001 |
| | 0.019 | 0.031 | | |
| Color | 0.2783 ± | 0.4179 ± | 50% | <0.0001 |
| | 0.021 | 0.019 | | |
| Fit | 0.2350 ± | 0.2168 ± | −8% | 0.0803 |
| | 0.015 | 0.012 | | |
| Impact | 0.2303 ± | 0.3211 ± | 39% | <0.0001 |
| absorption | 0.027 | 0.016 | | |
| Durability | 0.2409 ± | 0.2714 ± | 13% | 0.0334 |
| | 0.039 | 0.034 | | |
| Permeability | 0.1471 ± | 0.1916 ± | 30% | <0.0001 |
| | 0.020 | 0.017 | | |
| Stability | 0.1892 ± | 0.2073 ± | 10% | <0.0001 |
| | 0.031 | 0.025 | | |
| Overall | 4.536 ± | 4.735 ± | 4% | 0.0002 |
| | 0.0754 | 0.0718 | | |

Embodiments of the present disclosure take a new approach to promote diversity and desirability in GAN-based generative design models. The lack of these critical design metrics in the samples generated by alternative GANs is caused by the limitation of adversarial training between the generator and the discriminator to generate only “realistic” samples. To address this problem, a multimodal data-driven design evaluation model, DDE, is introduced in the discriminator to encourage the generator to get creative and generate more “unfamiliar” and potentially novel samples. Embodiments of the present disclosure also provide a user-centered generative model that can generate real products with high usefulness and attractiveness from the user's perspective. To bridge this gap, the DDE model is applied to predict the performance of the generator samples in each iteration. The predicted values are integrated with other loss functions and transmitted to the models for backpropagation. The generator is updated and optimized for integrated DDE loss and finally is enforced with the capability to generate well-performed designs. To investigate the effectiveness of the developed DDE-GAN model in generating images with high quality, high diversity, and desirability, the FID metric, the MMD, and the DDE testing tool are deployed to conduct the DDE-GAN experiment analysis with the baseline StyleGAN model.

Visual output and quantitative analysis validate the improvement of DDE-GAN. Specifically, the generated images contain novel features and characteristics from human observation and further quantitative analysis. Average FID scores confirmed the stability of the newly devised DDE-GAN and stated the sufficient ability of DDE-GAN to generate high-quality images. Lower MMD values again indicate that the DDE-GAN enhances the generator's ability to create more diverse samples. The DDE offline model was applied to test the two sets of novel images of DDE-GAN and StyleGAN, and DDE-GAN has demonstrated the ability to design samples with improved desirability and popularity. The developed DDE-GAN model was successfully tested in a sneaker design case study, but is flexible enough to be readily expanded to other product categories and can serve as an intelligent tool to produce photorealistic renderings of new concepts in other design applications.

Potential AI-augmented design tools can range from user-centered design evaluation, design generation, design selection, to design recommendation. Integrating extreme user behaviors, needs, and sentiment has been shown to increase design creativity and novelty. Further, the DDE-GAN model is developed to aggregate user feedback in the loss function to generate samples with high desirability from the perspective of users, which is a limitation that the produced sample conveys most of the user feedback. The DDE model was devised to extract visual and textual features and identify the dependency among various data types, such as image, text, and structure data. This work only partially used the image evaluation tools in DDE to inspire the generator to create enhanced and guided samples. Additionally, the DDE model will be efficiently used to assess samples with images and text information for a more accurate generative model.

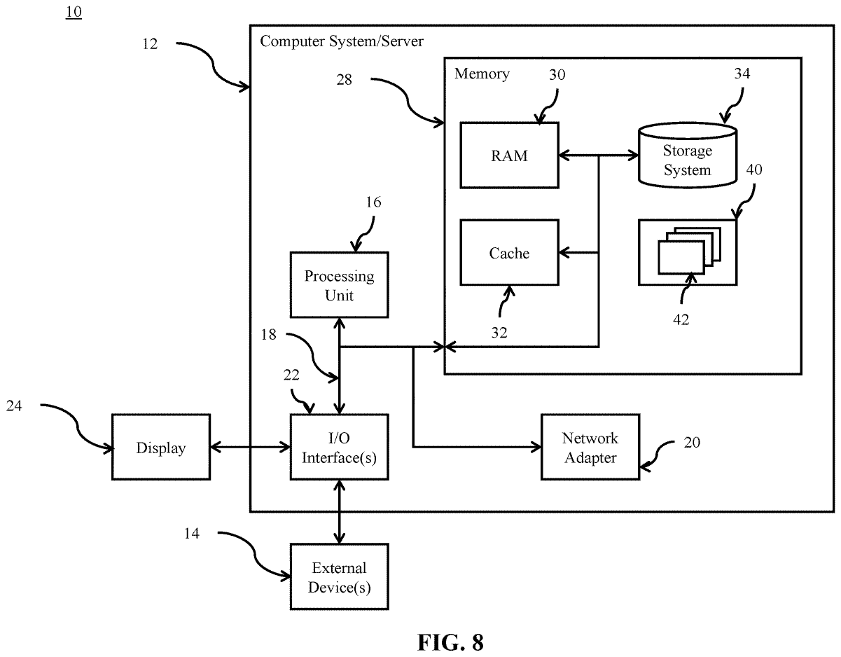

Referring now to FIG. 8, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (1/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for configurating a generative model to generating a sample, the method comprising:
providing a set of vectors in a latent space of a generative model to a generator;
generating a set of samples by the generator, each sample in the set of samples associated with a vector in the set of vectors;
providing the set of generated samples to an evaluator, and determining therefrom a first loss value of a first loss function, the first loss function being based on predicted performance of the set of generated samples;
providing the set of generated samples to a discriminator, along with a set of real data samples, and determining therefrom a second loss value of a second loss function, the second loss function being based on performance of the discriminator;
determining a composite loss value from the first and second loss values; and
training the generator based on the composite loss value.

2. The method of claim 1, wherein the evaluator is configured to output predicted performance of each of the set of generated samples with respect to a predetermined set of parameters.

3. The method of claim 1, wherein the evaluator comprises a residual network.

4. The method of claim 1, wherein the second loss function is a Wasserstein Generative Adversarial Network and gradient penalty (WGAN-GP) model.

5. The method of claim 4, further comprising training the discriminator based on the second loss value.

6. The method of claim 1, wherein training the generator comprises backpropagation.

7. The method of claim 6, wherein training the discriminator comprises backpropagation.

8. The method of claim 1, wherein the set of vectors comprise random noise samples from a uniform distribution.

9. The method of claim 1, wherein the generated samples comprise an image.

10. The method of claim 1, wherein the evaluator is trained based on a plurality of training images and associated text descriptions.

11. The method of claim 10, wherein the training images comprise one or more image from an internet source.

12. The method of claim 1, where the generator and discriminator together form a StyleGAN.

13. The method of claim 1, wherein the set of vectors further comprises a list of features.

14. The method of claim 11, wherein the associated text comprises a user evaluation of a sample design.

15. A system comprising a computing node, the computing node comprising a computer readable storage medium having program instructions embodied therewith, the program instructions executable by a processor of the computing node to cause the processor to perform a method comprising:
providing a set of vectors in a latent space of a generative model to a generator:
generating a set of samples by the generator, each sample in the set of samples associated with a vector in the set of vectors;
providing the set of generated samples to an evaluator, and determining therefrom a first loss value of a first loss function, the first loss function being based on predicted performance of the set of generated samples;
providing the set of generated samples to a discriminator, along with a set of real data samples, and determining therefrom a second loss value of a second loss function, the second loss function being based on performance of the discriminator;
determining a composite loss value from the first and second loss values; and
training the generator based on the composite loss value.

16. A computer program product for generating a sample, the computer program product comprising a computer readable storage medium having program instructions embodied therewith, the program instructions executable by a processor to cause the processor to perform a method comprising:
providing a set of vectors in a latent space of a generative model to a generator:
generating a set of samples by the generator, each sample in the set of samples associated with a vector in the set of vectors;
providing the set of generated samples to an evaluator, and determining therefrom a first loss value of a first loss function, the first loss function being based on predicted performance of the set of generated samples;
providing the set of generated samples to a discriminator, along with a set of real data samples, and determining therefrom a second loss value of a second loss function, the second loss function being based on performance of the discriminator;
determining a composite loss value from the first and second loss values; and
training the generator based on the composite loss value.
